(19) United States
(12) Patent Application Publication
(10) Pub. No.: US 2010/0312373 A1
(43) Pub. Date: Dec. 9, 2010

(54) METHOD AND SYSTEM TO DESIGN STANDARD BASIC ELEMENTS

(75) Inventor: Valerie Bertheau, Ville D'avray (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/478,045

(22) Filed: Jun. 4, 2009

(51) Int. Cl. G06F 17/50

(52) U.S. Cl. 700/103

(57) ABSTRACT

The invention pertains to the field of computer aided engineering. Methods and systems of the prior art do not address the current challenges of complex systems design because they do not provide methods and tools to define the parameters of reuse of components across a range of systems proposed to a number of different clients. The invention overcomes these limitations of the prior art by providing methods and tools to define the specifications of reusable standard basic elements (SBEs) as a function notably of the compliance rate to key customers requirements, cost-performance trade-offs, development costs and development time-line. The methods and tools of the invention are further improved by providing means to define part lists of said SBEs and also to add a second level of standardization of the SBEs at a building block (BB) level.

### FIELD OF THE INVENTION

The invention applies to the field of computer aided engineering (CAE), i.e. the set of methodologies and tools to help product/system designers become more productive.

### BACKGROUND PRIOR ART

A first generation of tools applied to product engineering. They addressed automation and integration of tasks which where manual and separate as mechanical, electrical, thermal, software designs. Improvements consisted in integrating in a single framework the successive periods of a product life cycle: specification, design, manufacturing, maintenance. These are known as Product Lifecycle Management (PLM) tools. Different tools, possibly from different editors, may be plugged in a single framework and share foundation services such as a common data repository, documentation generation and management, traceability, configuration and change management.

A second generation of tools addressed the specific needs of system engineering. A system is a collection of hardware and software items assembled together to perform a set of functions. A system is often designed to the specifications of a single client, to perform mission critical functions which are highly software dependent. Examples of such systems are: Command, Control, Communication, Computer, Intelligence, Surveillance, Recognition (C4ISR) systems; air defence and air traffic management systems, space vehicle launch systems, network management systems, homeland security systems, etc. . . . It is important to verify compliance of the components of the system and of the system as a whole to the client's requirements. This has to be done at various steps of the development of the system, mostly through modelling and simulation. Performance of definite functions will be assigned to components specifically designed for the system or bought off the shelf (Components Off The Shelf or COTS).

Due to the increased pressure on costs that contractors impose on system integrators, improvements of CAE methods have been designed to help designers and program managers reuse modules across different programs developed substiantially in parallel. But when a reuse target is not embedded in the original design of a product or system, it is not often possible to achieve such a goal. For doing so, it is necessary to come to a precise definition of the products' part lists for which reuse is contemplated. There is currently a need which is not addressed by the systems of the prior art, to define a parametric approach to reuse which would take into account precisely the structure of the product.

### SUMMARY OF THE INVENTION

To this effect, the invention provides a computer aided engineering method comprising the steps of: i) parsing key requirements of PBS elements of N products having similar applications, N being at least equal to two; ii) constructing P N-plets of PBS elements of at least some of the N products, each N-plet being populated with PBS elements which have a compliance rate with key requirements which is at least equal to a preset value; iii) if P is at least equal to one, defining for at least this one N-plet the specifications of a SBE meant to replace this one N-plet, said defining being performed by optimizing a combination of criteria chosen in a list comprising at least compliance rate with key requirements, cost-performance trade-off, development cost and development time-line of each product.

Advantageously, in the method of the invention, at least one of said N products meets the key requirements of at least one client through at least two different programs.

Advantageously, in the method of the invention, the at least one of said N products meets the key requirements of at least two clients which act on two different markets.

Advantageously, the method of the invention further comprises the step of defining the key requirements of said PBS elements by performing an operational and functional analyzis of at least one client or prospect.

Advantageously, the method of the invention further comprises the step of defining a support and obsolescence plan for at least one of the N products.

Advantageously, the method of the invention further comprises the step of defining at least two levels of PBS elements for said SBE.

Advantageously, the method of the invention further comprises the step of creating a part list for at least some of said PBS elements.

Advantageously, the method of the invention further comprises the step of generating block diagrams for at least some parts of said part list.

Advantageously, the method of the invention comprises the steps of: i) defining building blocks of Q SBEs having similar functions, Q being equal at least to two; ii) parsing key requirements of said building blocks of said Q SBEs; iii) constructing R Q-plets of building blocks of at least some of the Q SBEs, each Q-plet being populated with building blocks which have a compliance rate with key requirements which is at least equal to a preset value; iv) if R is at least equal to one, defining for at least this one Q-plet the specifications of a standard building block meant to replace this one Q-plet, said defining being performed by optimizing a combination of criteria chosen in a list comprising at least compliance rate with key requirements, cost-performance trade-off, development cost and development time-line of each SBE.

The invention also provides a computer system to implement the methods hereinabove pointed out.

Advantageously, the system of the invention further comprise a data repository module wherein marketing, product and technology data are made available to authorized users.

Advantageously, the system of the invention further comprises an interface with a CAD system to generate block diagrams of at least one part of at least one SBE.

Advantageously, the system of the invention further comprises an interface with a PLM system to manage configurations and obsolescence of parts of at least one SBE.

The invention also brings to the user the advantage of closely integrating marketing and technology roadmap definition, program and product definition throughout the management organization of a company using the processes and the systems of the invention, and thus of minimizing program management risks over time.

### BRIEF DESCRIPTION OF THE DRAWINGS

FIG. 1 represents the main inputs and outputs of a product plan definition process from/to the other main processes of a company and the decision gates according to an embodiment of the invention.

FIG. 2 displays an organization chart and a flow chart which define the responsibilities in setting the product and standardization policies according to an embodiment of the invention.

FIG. 3 displays a modular structure of a tool to define a product policy according to an embodiment of the invention.

FIGS. 4a and 4b display a more detailed description of the functions of the tool of FIG. 3.

FIG. 5 displays a modular structure of a tool to define a standardization policy according to an embodiment of the invention.

FIG. 6 displays a more detailed description of the functions of the tool of FIG. 5.

FIGS. 7a and 7b respectively display products and standardization portfolios cartographies according to an embodiment of the invention.

FIG. 8 displays the tree of combination of the various inputs of a Product Plan according to an embodiment of the invention.

FIG. 9 displays the operational and functional analysis processes to define SBEs and BBs according to an embodiment of the invention.

FIG. 10 displays an example of a key requirements matrix according to an embodiment of the invention.

FIG. 11 displays an example of a table of standardization criteria according to an embodiment of the invention.

FIG. 12 displays an example of a PBS of a product according to an embodiment of the invention.

FIG. 13 displays an example of products and SBEs road maps according to an embodiment of the invention.

FIGS. 14a and 14b respectively display examples of computer screens with the functional steps to define a product plan and a standardization plan according to an embodiment of the invention.

### DETAILED DESCRIPTION OF THE INVENTION

In relation to the figures listed hereinabove and the following text of the specification, we define the following acronyms and abbreviations, which will have the meaning mentioned in the table hereinbelow, unless otherwise indicated in the detailed specification:

| Acronym/Abbreviation | Meaning |
|---|---|
| BB | Building Block |
| BD | Business Development |
| BL | Business Line |
| BP | Business Plan |
| C4ISR | Command Control Communication Computer |
| | Intelligence Surveillance Recognition |
| CAD | Computer Aided Design |
| CAE | Computer Aided Engineering |
| COTS | Components Off The Shelf |
| ERP | Enterprise Resource Planning |
| Dva | Design validation |
| IRR | Internal Rate of Return |
| IVVQ | Integration Verification Validation Qualification |
| KSF | Key Success Factor |
| LTBP | Long Term Business Plan |
| MBT | Make Buy or Team |
| MidTB | Mid Term Budget |
| NRC | Non Recurring Costs |
| PBS | Product Breakdown Structure |
| Plm | Product line manager |
| PLM | Product Life cycle Management |
| PMC | Product Management Committee |
| RC | Recurring Costs |
| SBE | Standard Basic Element |
| SDA | Senior Design Authority |
| SMC | Standardization Management Committee |
| SWOT | Strengths Weaknesses Opportunities Threats |
| TAP | Technology Acquisition Plan |
| TBU | Technical Business Unit |
| TRL | Technology Readiness Level |
| Tsm | Technical standardization manager |
| TSP | Technology Strategic Plan |
| WBS | Work Breakdown Structure |

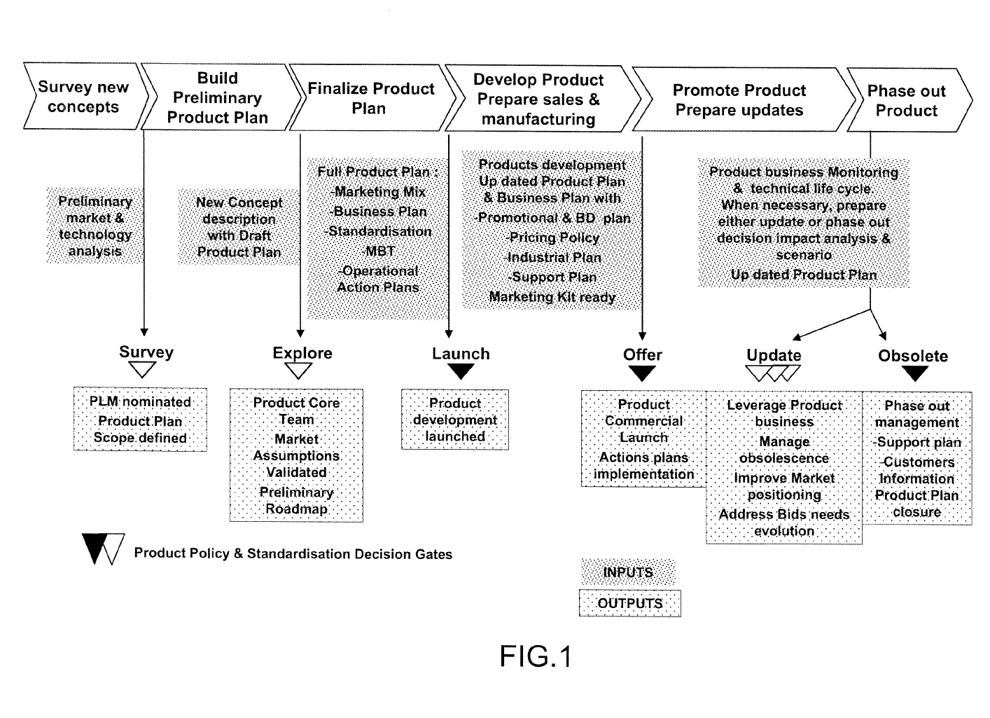

FIG. 1 represents the main inputs and outputs of a product plan definition process from/to the other main processes of a company according to an embodiment of the invention.

The definition of a product plan is the main process in a company which addresses a number of clients, possibly on different markets, to which different solutions have to be proposed to satisfy their operational needs. Pressure on costs from clients makes it mandatory for said company to be able to define a process which allows definition of products which can be reused across programmes and sold to different clients, possibly on different markets. The problem to be solved is to be able to define product plans which meet the requirements of the company's clients when they need said products. This requires strong coordination throughout the organization of the company, between marketing managers, sales managers, programme managers, product development managers and technology development managers. This requirement needs to be achieved though the lines of management reporting within the organization may be different. Also, these lines of management may use different program management, CAE, CAD, or ERP tools.

To achieve fulfilment of these requirements, according to an embodiment of the invention, a Product Plan is defined and rolled out in a sequence comprising the following steps:
Survey new concepts: this step consists in performing a preliminary market and technology analysis from data which is collected for this purpose from internal and external sources and outputs a definition of a scope of a product plan which is entrusted to a Product Line Manager (PLM);
Preliminary Product Plan: this step consists in describing the new concept underlying the product from an analysis of a combination of requirements gathered from the marketing organization and drafting an outline of a Product Plan; the preliminary product plan includes: Market Analysis and Competitive benchmark, draft road map, preliminary marketing requirements; a product core team is assigned to the project which will work in an exploration mode, the market assumptions need to be validated and a preliminary roadmap needs to be defined;
Full Product Plan: this step consists in defining a marketing mix (which markets the product will address, at what price); a Business Plan (revenue projections, gross margin, R&D expenses, Marketing and sales expenses, General and administrative expenses, investment and depreciation, income from operations, cash flow from operations, internal rate of return); Make, Team or Buy analysis (Make: which parts of the product should be sourced in house; Team: which parts of the product need to be sourced through a cooperative development agreement; Buy: which parts of the product need to be sourced from suppliers); the output of this step is the launch of the development of the product after Design validation (Dva);
Develop Product—Prepare sales and manufacturing: this step consists, while the development is on going, in updating the Product Plan and the Business Plan by adding:
   A promotional and business development plan;
   A pricing policy;
   An industrial plan;
   A support plan;
   A marketing kit;
As an output, the Product should be offered on the market, with action plans to be implemented;
   Promote Product—Prepare updates: this step consists in monitoring the business and technical life cycle of the Product and preparing updates and, possibly, phase outs, these decisions being submitted to a Design validation;
in case the decision is taken to update, the output of this step should address the following issues:
   Leveraging Product business on other segments;
   Managing obsolescence;
   Improving market positioning;
   Addressing evolutions needed for future bids;
In case the decision is taken to declare the Product obsolete, the output of this step should address the following issues:
   Managing phase out;
   Defining a support plan;
   Informing customers;
   Closing the Product Plan.

FIG. 1 also displays the decision gates for defining a product plan according to an embodiment of the invention.

This figure illustrates the necessary links between the marketing/business development activities and the product development activities in a process according to the invention. A key process in a matrix organization of the type in which a process according to the invention is the Business Plan (BP) which defines the achievable targets in terms of revenue/income within a time horizon, based on hypotheses about the products to be developed and sold. Advanatageously, the BP will be broken down in two phases according to at least two different time horizons. LTBP (Long Term Business Plan) will outline the long term strategic goals and allocated resources of the company for a product portfolio addressing a market segment. Typically, depending upon the rate of market obsolescence of the products under review, the time horizon for LTBP will be from 5 to 10 years or more. MidTB (Mid Term Budget) will outline the short to medium term goals of the company for a product portfolio addressing a market segment. Typically, depending upon the rate of market obsolescence of the products under review, the time horizon for MidTB will be from 1 to 3 years.

According to an embodiment of the invention, the Product Plan Gates should comprise:
Survey: preliminary market and technology analysis;
Explore: preliminary Product Plan;
Launch: start product development;
Offer: start to market and promote the product, organize manufacturing and support activities, qualify product development, update Product Plan and Business Plan; define promotion and sales activities; define product manufacturing and support activities;
Update: manage obsolescence; improve market positioning;
Obsolete: support plan and customers information (product line road map; Product Plan closure)
   Among these, the mandatory gates for a Product Policy are: Launch, Offer, Obsolete.

There is also a need to define a Standardisation Plan to be in a position to minimize product development costs by reusing common modules within the the architecture of a definite Product Work Breakdown Structure (WBS). A standardized sub-system is a sub-system which is reused in more that one Product Plan.

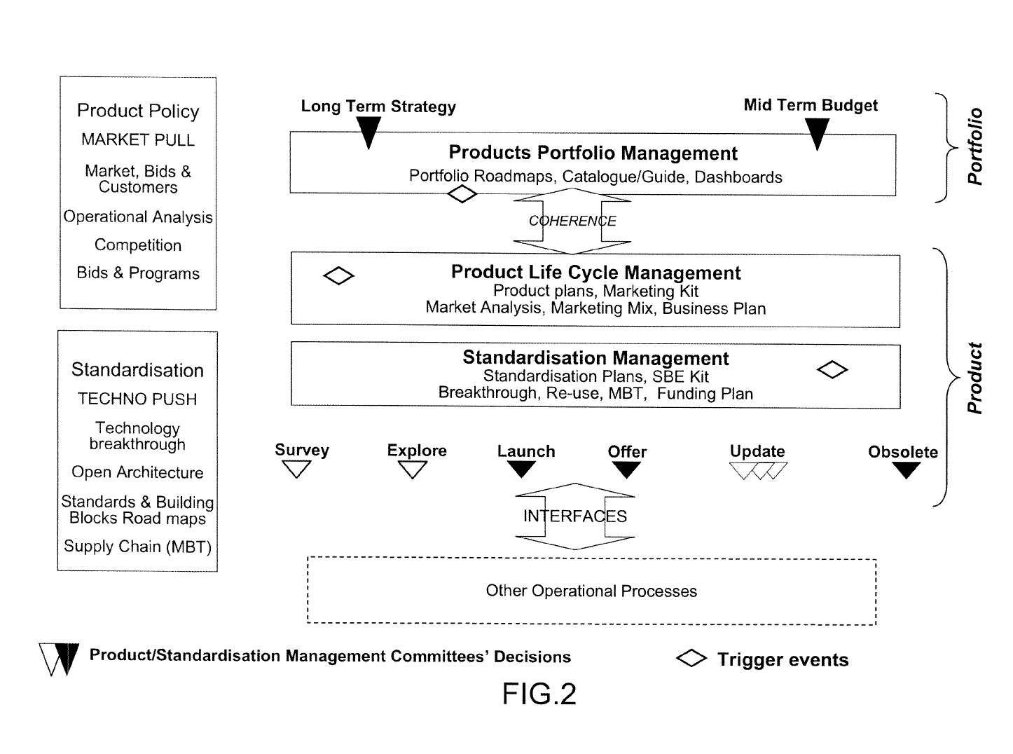

FIG. 2 displays an organization chart and a flow chart which define the responsibilities in setting the product and standardization policies according to an embodiment of the invention.

As in all other processes, it is important to appoint a process owner who is tasked with monitoring first results of market and product tests to make sure that the terms and conditions contemplated are still in line or should be amended. It is for instance mandatory to confront Market pull and Technology push. In a traditional corporate matrix organization, business responsibility (selling to clients) and technology responsibility (developing technologies and products), the first outline of a Business Plan (BP) is drawn by a Business Line (BL) which is responsible for a market segment. Then the BP is challenged/documented after a discussion with the parts of the company which are tasked with developping products/technologies (Technology Business Units or TBUs).

The first step of the process (which is market pull oriented) comprises:
An analyzis of the market, the bids, the clients;
An operational analyzis of the clients' requirements;
An analyzis of the competitors:
   What are the Key Success Factors, if directly competing against them?
   What are the Strengths Weaknesses Opportunities Threats when competing against them (SWOT analyzis)?

The second step of the process (which is technology push oriented) comprises:
An analyzis of the portfolio of technological breakthroughs of the company;
A vision on how to use open architectures;
A definition of Standards and Buiding Blocks (BB);
A view on the Make Buy Team (MBT) decisions to be made.

The outputs of the process should include: i) Product Plans (Marketing mixes; Business Plans); ii) Standard Basic Elements (SBE)/BB Standardization Plan (Breakthroughs, Re-use, MBT, Funding).

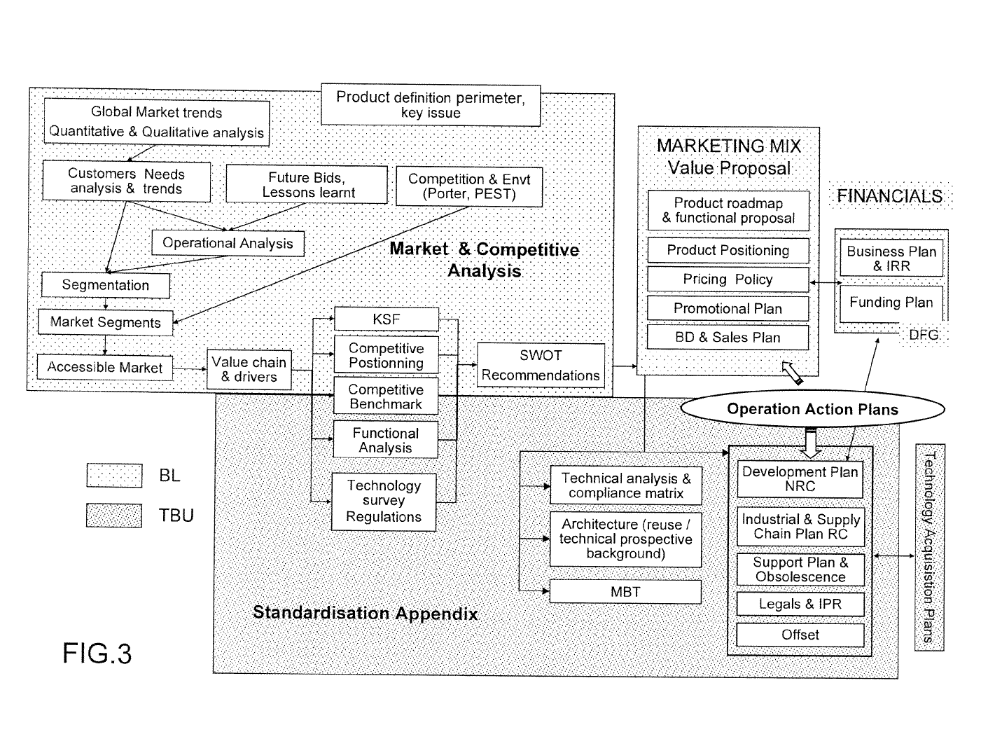

FIG. 3 displays a modular structure of a tool to define a product policy according to an embodiment of the invention.

Software modules can be defined to implement the various steps of the process to define a product policy.

As can be seen on FIG. 3, said software modules would preferably comprise three first modules, mainly operated at Business Line level, to produce marketing and financial data which need to be defined:
A first module to perform Market & Competitive Analyzis; said module will be, for example, organized in sub-modules to perform the individual functions listed on the figure;
A second module to define the Marketing Strategy and action plans;
A third module will compute the financials from the revenue and cost side of the Product definition, said cost side needing input from the Operations Action Plans module referred to hereinbelow.

The fourth module, pictured in the bottom part of FIG. 3, is targeted at defining the Operations plans, down to the list of parts needed to assemble the product corresponding to the marketing definition from the 3 first modules. This fourth module is mainly operated at Technical Business Unit level. As will be seen further down in the description, a key sub-module configures a “Technical analyzis and compliance matrix”.

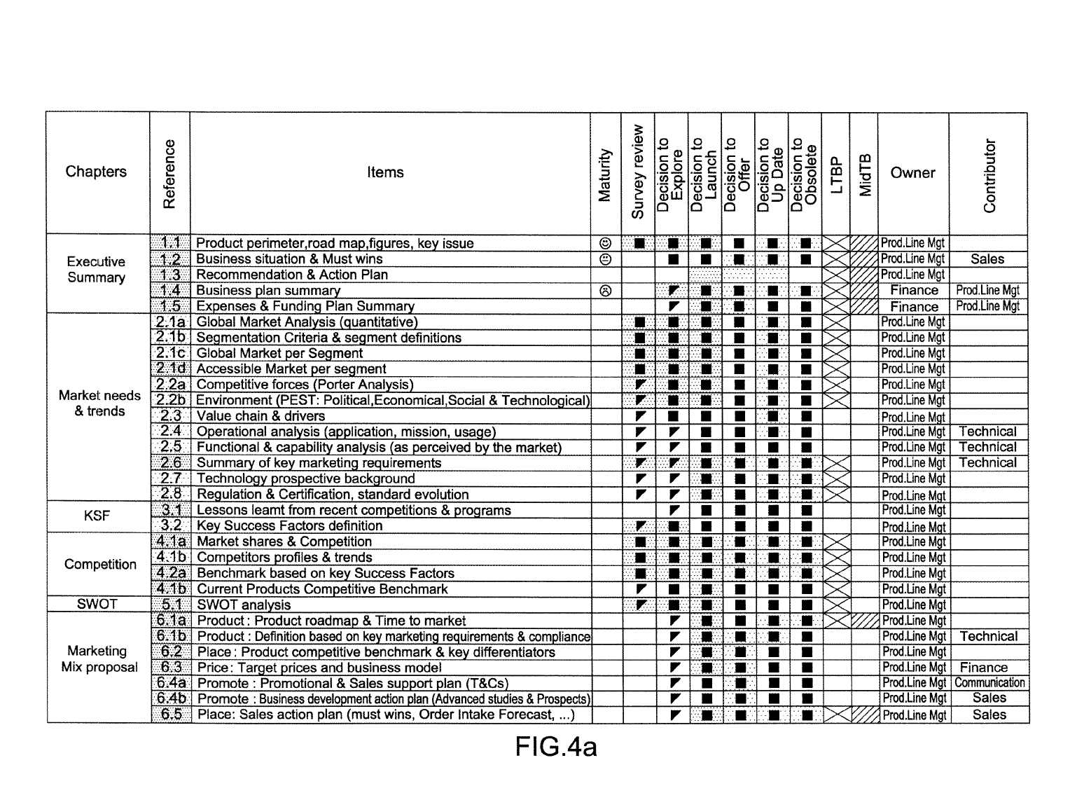

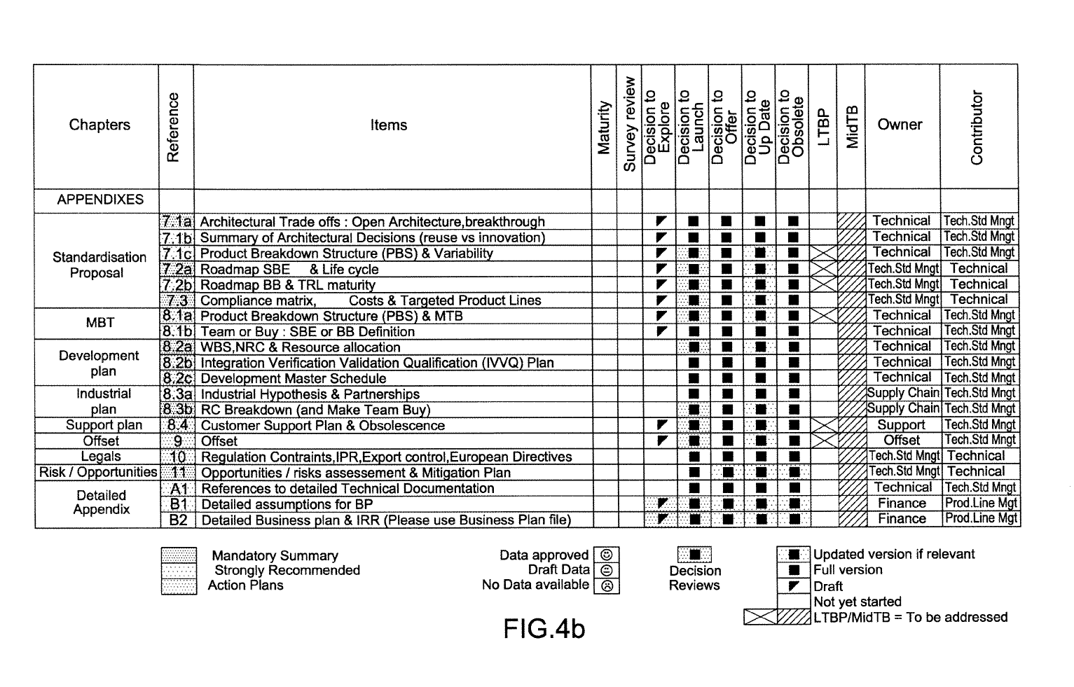

FIGS. 4a and 4b display a more detailed description of the functions of the tool of FIG. 3.

The lines of the matrix of FIGS. 4a and 4b display the different processes to be implemented with a three level tree structure and the columns the decision gates, the business plan processes to which they are related and the process owners.

FIG. 4a contains the processes which are related to marketing or competive analysis which are essential to define the requirements of the products to be designed.

FIG. 4b gives details on how the product plan will be rolled out.

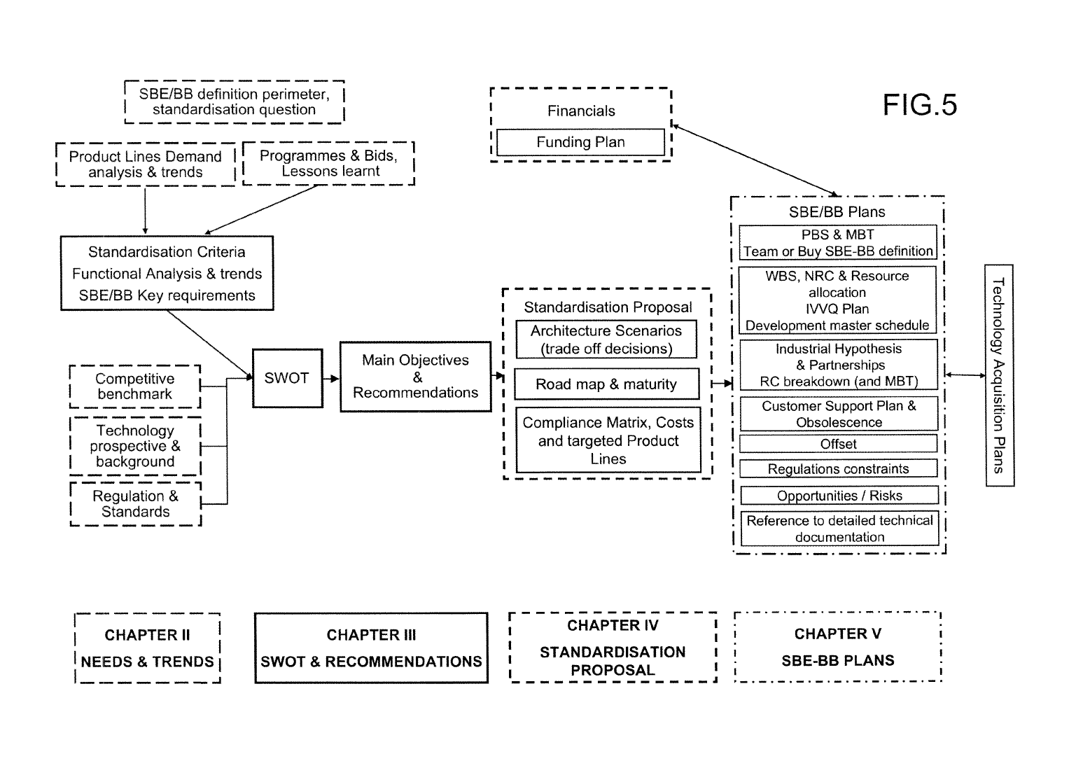

FIG. 5 displays a modular structure of a tool to define a Standardization policy according to an embodiment of the invention.

The design and manufacturing costs of a set of products will be more advantageous if Standard Basic Elements can be defined, which may be shared across Product lines. For example, in a company which markets surface radar detection systems which can be positioned either on a land vehicle or a vessel, two different radars will be probably defined to satisfy the operational and functional requirements of the clients of the two kinds of systems. For instance, a radar on board a vessel will need specific processing to eliminate sea clutter and multipath processing will be very different. But for the same power and range, il will probably be possible to define for instance antennas, transmit and receive modules (T/R modules) and power supplies as common SBEs shared by the two radar products. If we go one level down in the Product Breakdown Structure (PBS), it is possible to define Building Blocks (BB) which will be common to the previously defined SBEs but also to SBEs which will be parts of other products. For instance, in the case of surface radars, radars of different powers and ranges will have different array antennas, but these array antennas may have the same type of array elements and T/R modules, defined as BBs, the difference between the two antennas being the number of array elements and T/Rs modules, their assembly and, possibly their signal and data processing.

The software modules listed on FIG. 5 are used to define such SBEs and BBs. As will be discussed further below in the specification, the key elements are the compliance matrix, the trade-off decisions between design decisions in view of the rates of compliance and the development road-map. It is probable that choosing a SBE instead of a tailored product will lead to a lower rate of compliance to the clients requirements but will lower Non Recuring Costs (NRC) and Recuring Costs (RC) because of the larger number of products in which the SBEs will be included. Before coming to the definition of the list of parts that SBEs/BBs will comprise, it is necessary to produce a number of plans which are listed on the right hand part of FIG. 5.

The PBS is the tree structure of the SBE/BB definition which will be used to generate the part lists of said SBEs/BBs at the end of the process. The Work Breakdown Structure (WBS) is the project structure to develop the SBEs/BBs with resources, costs, timeline and milestones.

The Integration Verification Validation Qualification (IVVQ) plan is defined to check compliance of the product at the various decision gates with the approved design.

The Industrial plan defines the sourcing and manufacturing options with associated Recurring Costs (RC).

The Documentation Plan defines how, when and at what costs, the SBEs/BBs documentation will be produced and delivered.

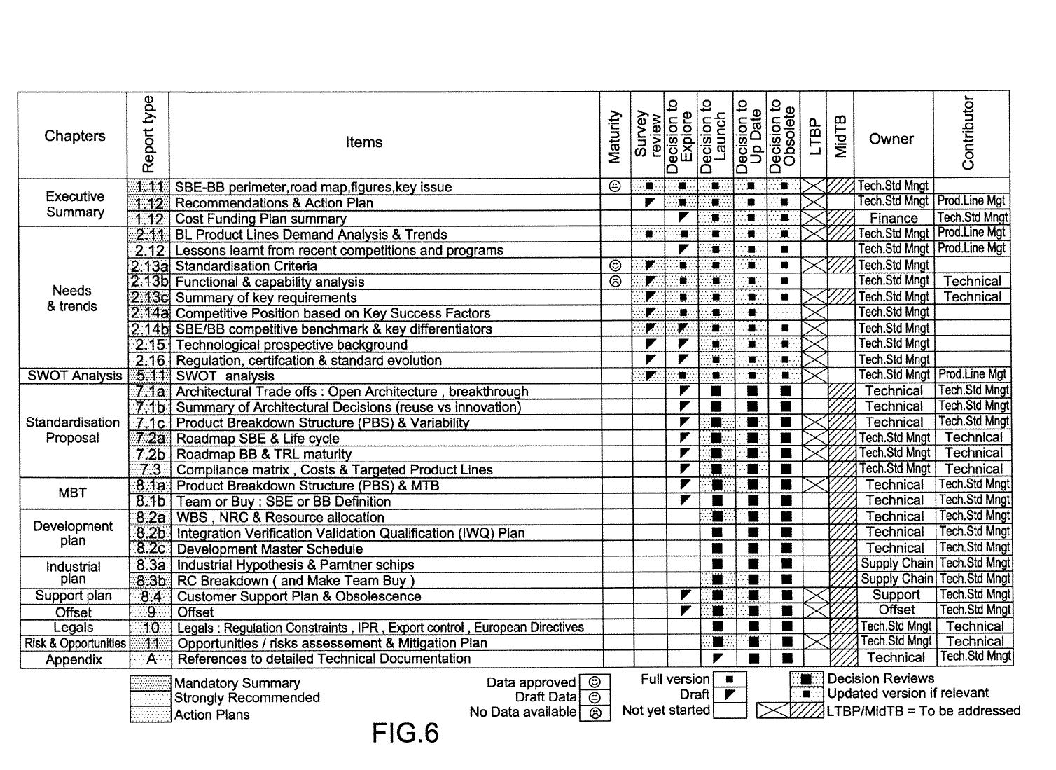

FIG. 6 displays a more detailed description of the functions of the tool of FIG. 5.

The structure is the same as for the Product Plan (same colums) except that there is no marketing analysis at this point and that the various design, validation or manufacturing processes apply to SBEs and BBs.

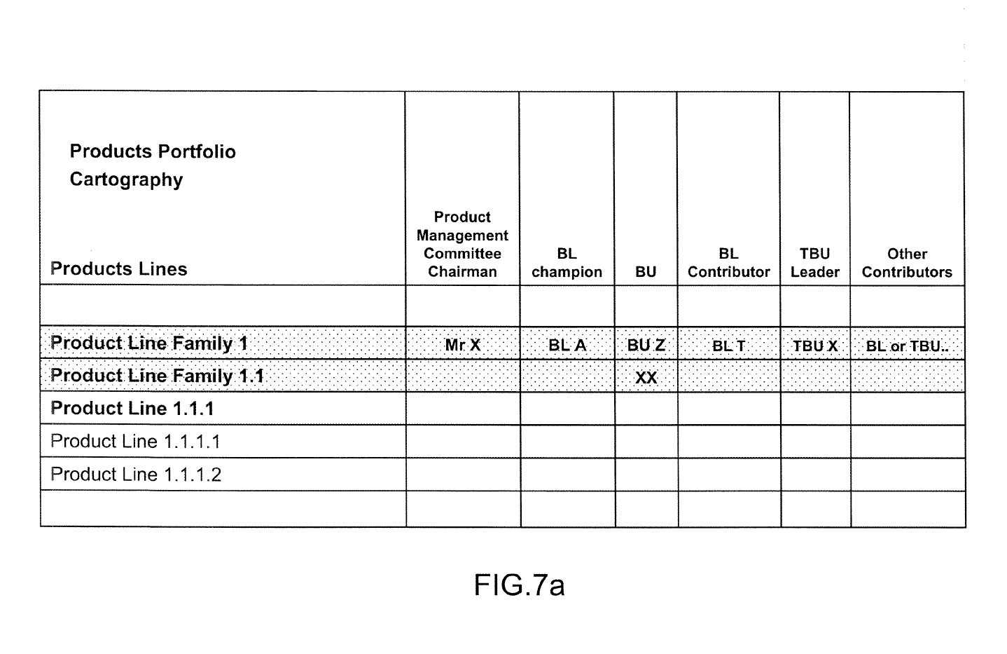

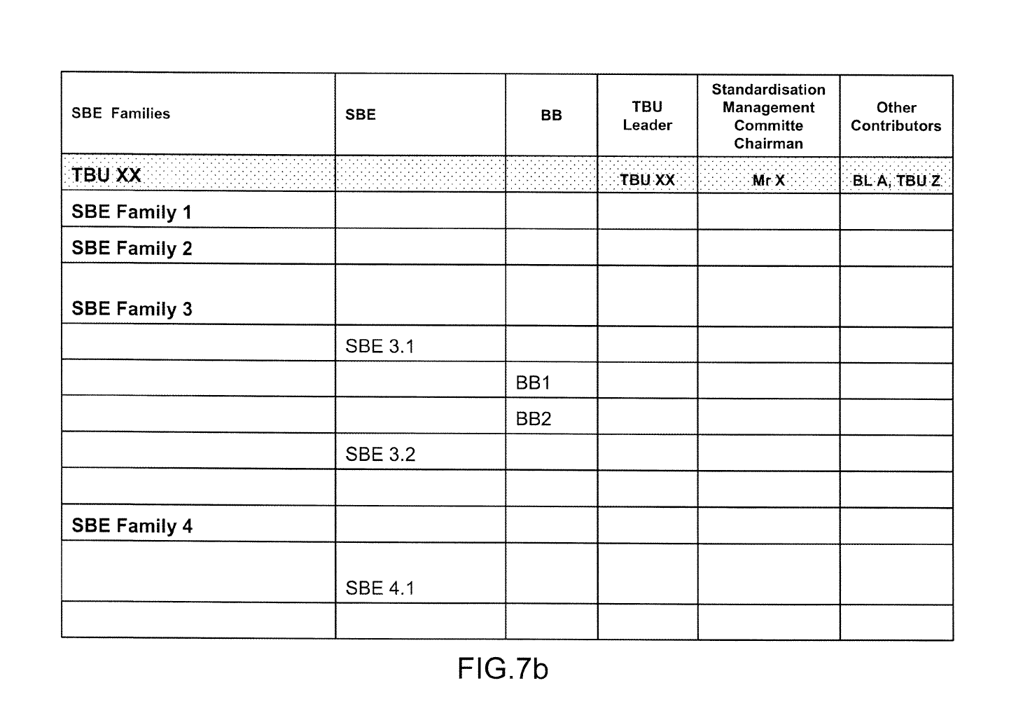

FIGS. 7a and 7b respectively display products and standardization portfolios cartographies according to an embodiment of the invention.

FIG. 7a displays in lines the list of Products for which Products Plans are defined with, in columns, the roles of the different parts of the organization which contribute to the definition/validation of the Product Plans. The leading organization for the definition of a Product Plan is a BL, whereas other BLs and some TBUs will contribute.

The number of levels of the PBS can be different from a Product to an other. In the example of the figure, there are four levels of PBS but there may be less or more.

FIG. 7b displays in lines the list of the SBEs for wich Standardization Plans are defined with, in columns, the roles of the different parts of the organization which contribute to the definition/validation of the Standardization Plans. The leading organization for the definition of a Standardization Plan is a TBU, whereas other TBUs and some BLs will contribute. In a well structured Standardization Plan, the PBS should go down to the level of Building Blocks (BBs) which can be common to different SBEs. On the example of the figure, the PBS goes down to the sub-system one level. Each sub-system can include BBs which are displayed in colums.

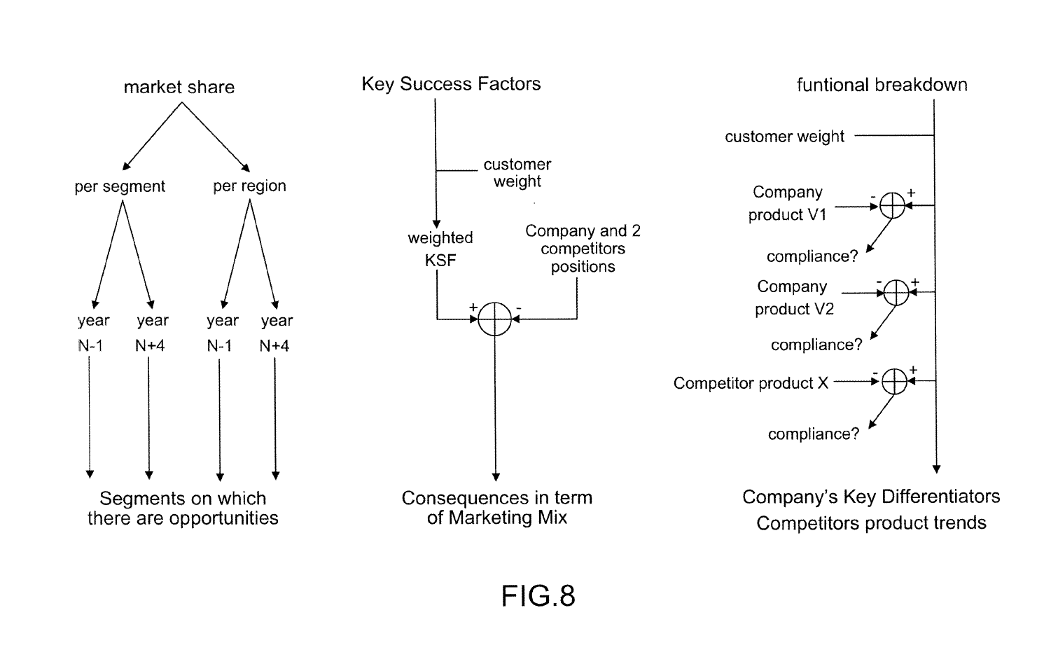

FIG. 8 displays the tree of combination of the various inputs of a Product Plan according to an embodiment of the invention.

One of the input of the Product Plan (displayed on the left-hand side of the figure) is the market share which is targeted, per sales segment and per region, with a view of the market share before implementation of the plan and 4 years after its roll out.

The middle viewgraph of the figure displays the impact of the KSF on marketing mix. The KSF are positioned in relation to the same factors evaluated, for example, for the two main competitors of the company on the definite segment for which the Product Plan is defined.

The right-hand side of the figure viewgraph displays the evaluation of the compliance rate for two successive versions of the product which is the object of the Product Plan in relation to the main competitor's product for the different functions into which the product which is the object of the Product Plan is broken down.

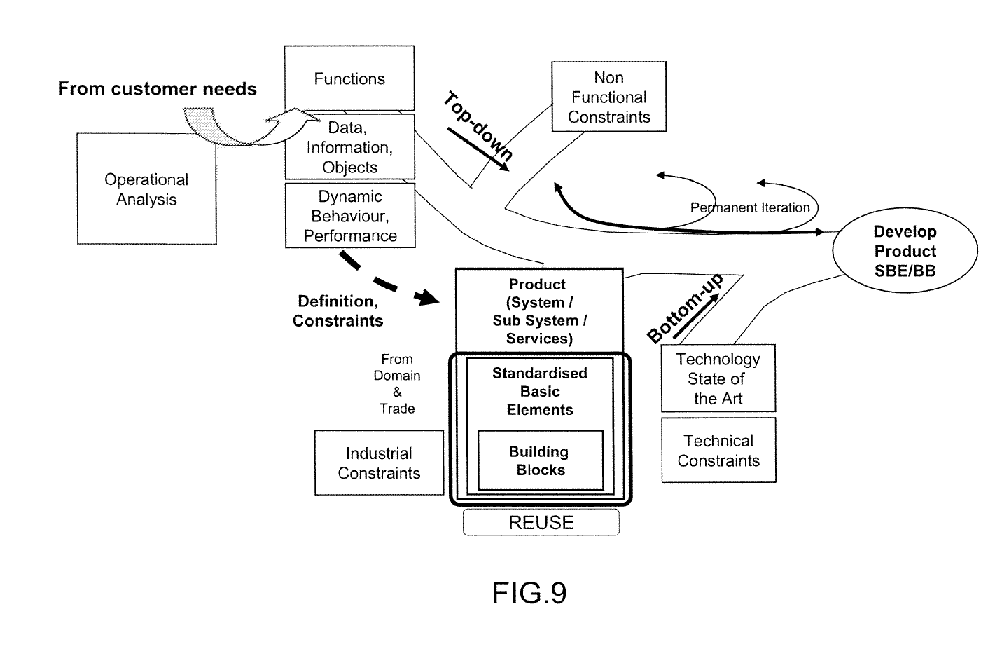

FIG. 9 displays the operational and functional analysis processes to define SBEs and BBs according to an embodiment of the invention.

From the customer needs, we define the behaviour that the product must have in operation (operational analyzis). The product is also broken down into functions to be performed to fulfill the operational needs (functional analyzis). In the example of the figure, the defined functions include:
Data, Signals, Objects;
Dynamic Behaviour Performance;
. . .

The operational and functional analyzes define technical and non technical constraints through a top-down approach.

The design of the SBEs and BBs is derived from these constraints. In the course of said design, the technology state of the art is assessed and can be feeded back to the operational and functional analyzes in a bottom-up approach to optimize the key requirements compliance matrix, which is presented below.

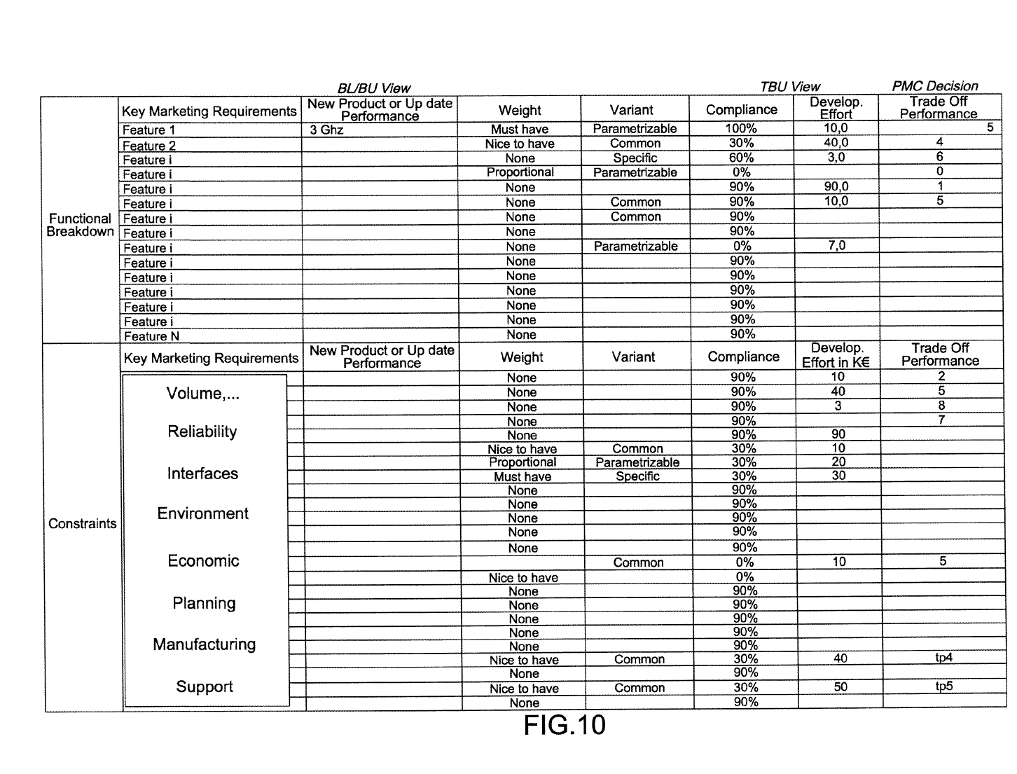

FIG. 10 displays an example of a key requirements matrix according to an embodiment of the invention. The list of requirements is drawn out from the marketing and the operational analyzes carried out as explained above. Then, based on a combination of marketing criticality factors (size of the market, “must win” bid, etc. . . . ) and operational criticality factors (for instance: weight, furtivity, wheather conditions, security conditions, etc. . . . ), the requirements will be marked as explained below.

For each feature of a Product, which are listed in the lines of the table displayed on the figure, the following factors are listed in columns:
The view of the relevant BL on the performance to be achieved to meet the client's requirements;
From the relevant BL's perspective, the extent to which said performance for the defined feature is needed in the product:
   “Must have” applies to a mandatory performance for said feature:
   “Nice to have” applies to the performance of said feature if useful but not mandatory;
   “Proportional” applies to the performance of said feature when the customer requires more and more performance with no limitation;
   “None” applies to features which have no impact on the key requirements from the client's perspective;
From the relevant BL's perspective, the extent to which the performance of said feature can be adapted through different versions of the product:
   “Parametrizable” applies when the performance of said feature can be tuned without any development of the product by the contractor;
   “Common” applies when the performance of said feature can be the same across the Product line through all the segments
   “Specific” applies when the performance of said feature is seen to be unique to the product developed for the defined client;
From the relevant TBU's perspective, “Compliance” is the extent to which the key requirements of the client are met if this design choice is made;
“Development effort” is the cost of the development of the feature indicated by the relevant TBU;
The last column on the right of the table displays the decision of the PMC with a level of performance as a result of the trade off between marketing requirements and technical answer (compliance rate)
   The same analyzis is carried out for the constraints which, in the example of the figure, comprise physical elements (such as volume, three dimensions size, reliability, interfaces, environment, economic parameters, planning, manufacturing, support . . . )

As a variant, the key requirements can be marked and ranked using customer value metrics. One of them can be found in James C. Anderson and James A. Narus, “Business Market Management: Understanding, Creating, and Delivering Value” (Prentice Hall, 1999). In this metric, a product's “value” to a business customer consists of two different things. The first is all the “benefits” the customer stands to receive from the product over the course of its useful life. The second is all of the “costs”—other than the price of the product—that the customer will incur in conjunction with obtaining those benefits. Anderson and Narus suggest that the best way to think of this “value” is as the “net benefit” the customer can expect to get from the product or service when all the benefits it delivers are combined with all the costs associated with its use, excluding its price. When applying this method to the requirements of a product, a monetary value will be given to each required feature and the net benefit will then be compared to the price at which the product is expected to be sold to the customer.

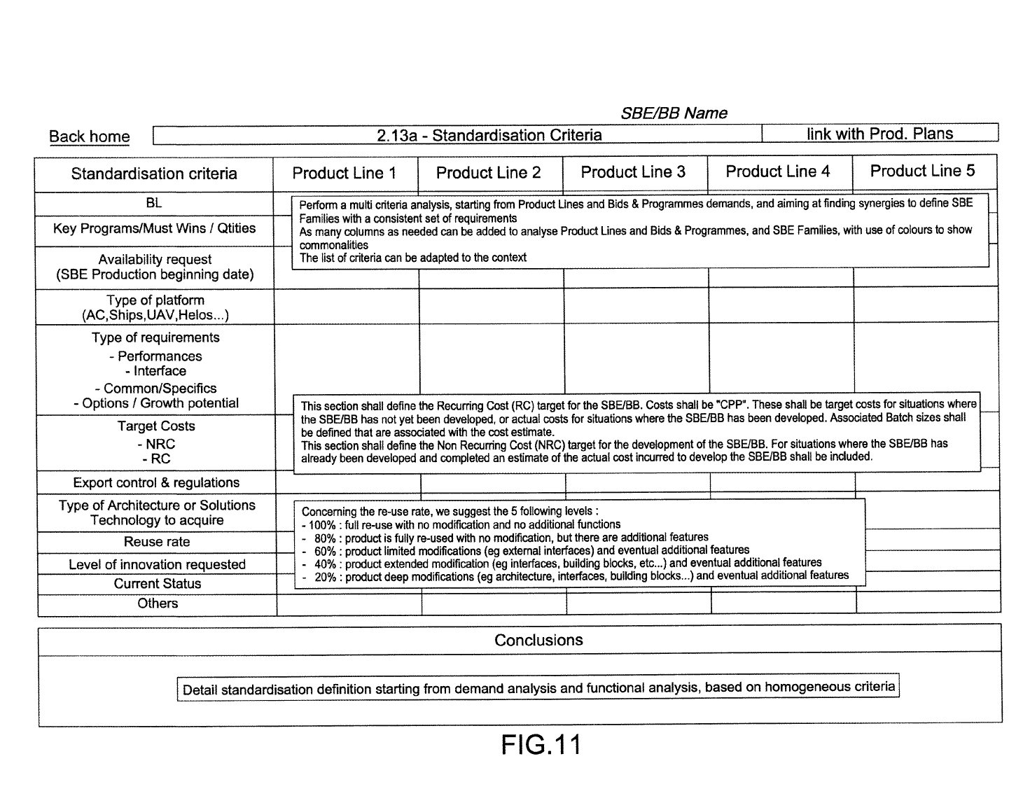

FIG. 11 displays an example of a table of standardization criteria according to an embodiment of the invention.

This table is an example of a list of standardization criteria (in lines) which will be used to decide if standardization is feasible across a list of Product lines (in colums) in view of the marketing and technical constraints which have been identified through the previous steps of the process:
Key programs, Must win, Quantities: what is the criticity of fulfilling the specific requirements of a definite list of programs in view of the overall objectives of the BL? What is the number of units to serve these needs? A higher criticity and number of units, will lower the request for standardization;
Availability of SBEs: a remote availability date will lower the request for standardization;
Type of platform: air carrier or ship, which is key to determine in which environment the Product will be placed
Type of requirements: functional requirements across product lines, market segments bids and programs;
Target costs (NRC, RC): this will constrain the decision if the programs cannot support these costs;
Export control & regulations: these factors may prevent from standardizing; these are equivalent to a constraint that the product remain specific to a definite client or market segment;
Type of architecture, solutions, technology to acquire: technical requirements across product lines, market segments bids and programs;
Reuse rate: this rate helps to evaluate the actual extent of standardization for a definite Product line; a homogeneous high rate will be an indication that this SBE must be high on the list of priorities, when decision must be made between various Standardization Plans;
Level of innovation requested: this is an indication of the level of risk of a Standardization Plan; a high level will lead to lower this Standardization Plan in the order of priorities;
Current status: what is the extent to which the SBEs of this definite Standardization Plan are already used across the Product lines.

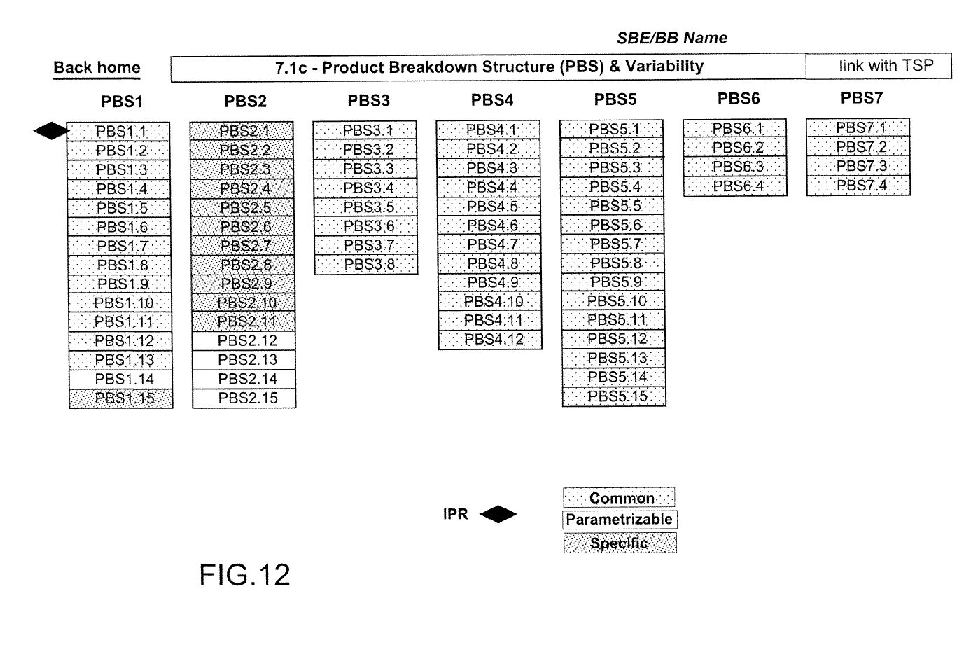

FIG. 12 displays an example of a PBS of a product according to an embodiment of the invention.

This PBS is a two level breakdown structure. Each element is a part which can be defined at an adequate level of detail to be able to either launch a manufacturing order or a request for proposal from potential suppliers..For example, if the Product family is Single Board Computers (SBC), the list of requirements will determine the types of Digital Signal Processors (DSP), Analog to Digital Converters (ADC), memories, filters, connectors, etc. . . . There will be sub-families of SBCs depending on their application: intensive signal processing in a radar front-end, image or sound processing, satellite channel signal processing in a global positioning system, etc. . . . The constraints will also define the type of ruggedization which will be needed (standard, tempest, military). DSPs and ADCs are BBs and will be defined at the lowest level of PBS. The filters may be more complex depending on the algorithms implemented on the SBCs (for instance a Kalman filter) and may have a finer grain definition of PBS. The level of variability of the PBS elements is displayed on the figure by a code so that the elements which can be reused either by parametrization or by a simple design adaptation can be immediately apparent.

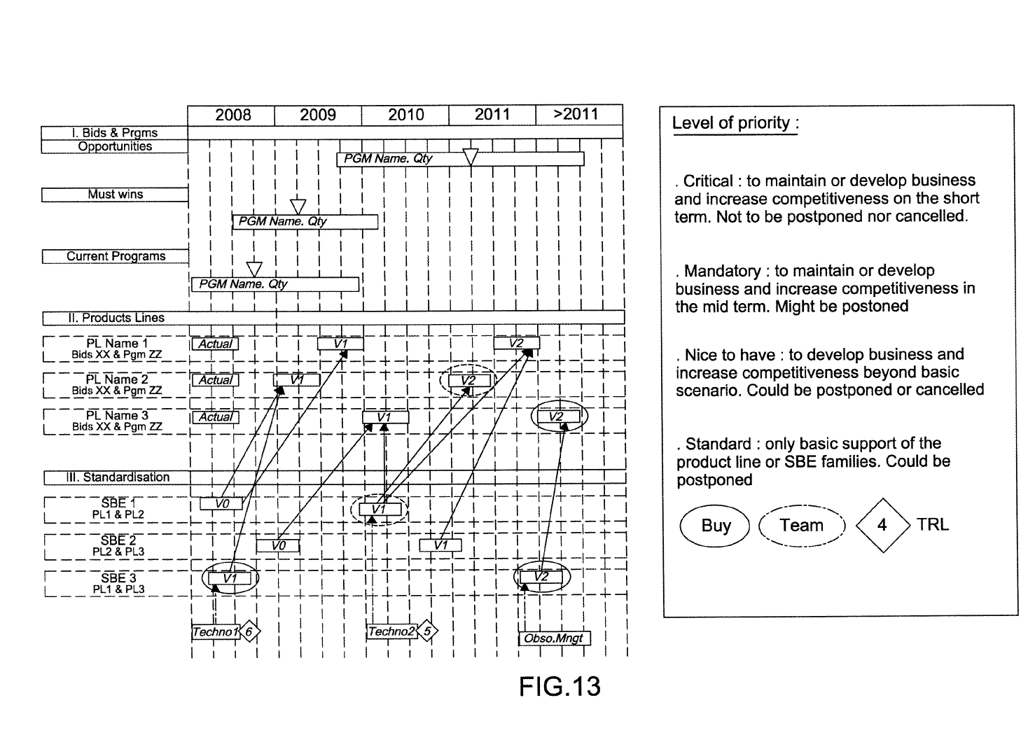

FIG. 13 displays an example of products and SBEs road maps according to an embodiment of the invention.

It is an important feature of the Product Plan and Standardization processes that they are consistent timewise. In effect, the various versions of the products and the SBEs must be available at the gates which have been defined in each of the plans. The road maps with parallel views of both plan gates on the same timeline is important to achieve this goal.

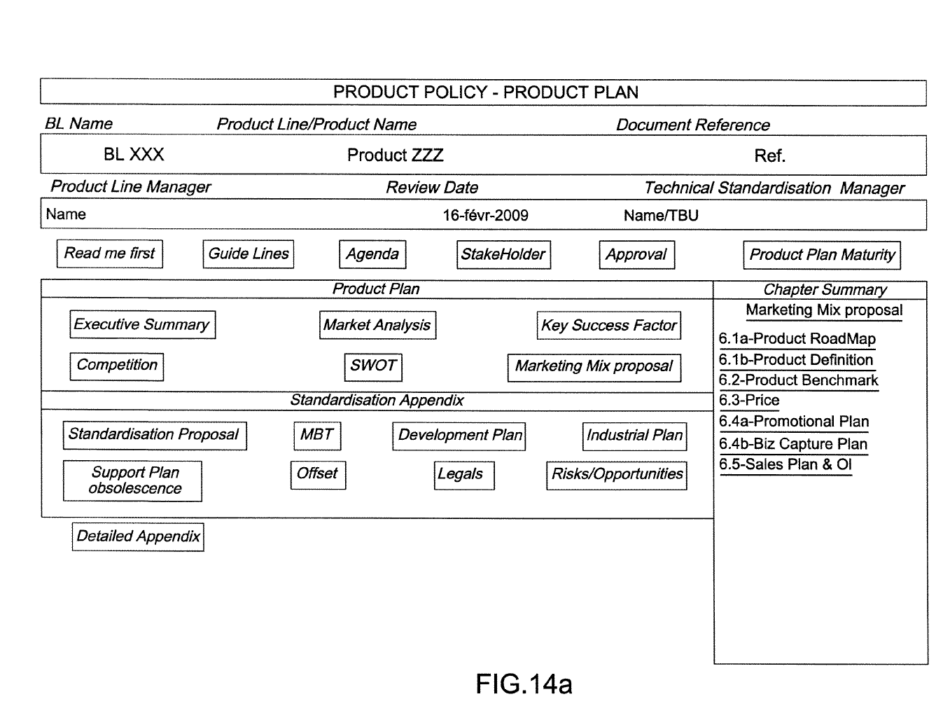

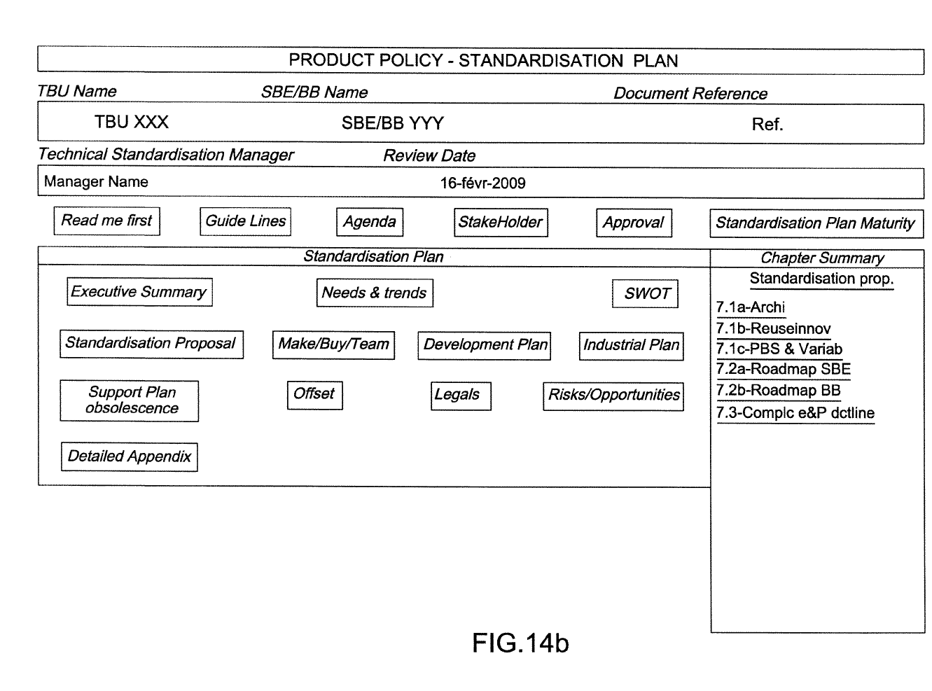

FIGS. 14a and 14b respectively display examples of computer screens with the functional steps to define a product plan and a standardization plan according to an embodiment of the invention.

Any software package which can provide a data entry/storing facility, a graphic interface, an interface to transfer data from other packages (for instance to produce marketing reports from data surveys) and to CAD/CAE packages can be used. The two figures display an example of a lay out of the menus on two screens to access the main functions/processes of the system.

The various steps of the process of the invention enable the users in a company to start from a collection of marketing data, clients' operational and functional requirements, technology portfolio data to define Product and Standardization Plans. The objective is to maximize reuse and get as an ouput the part lists at a level of detail which is sufficient to execute a plan to produce SBEs and BBs which will be used to build the products to meet the company's clients' requirements at defined gates.

The architecture to use the process of the invention is not complex: a set of personal computers, possibly connected to a server through a network will meet the technical requirements to implement the inventin. It is though advantageous to have a common data repository to make these data available to all the users of the system. In this manner, the SBEs and BBs specifications, the Products and Standardization Plans and the marketing data can be viewed by the BLs/TBUs users on a need to know basis, provided however that an adequate module is included to define and enforce access rights. It is also advantageous that the system of the invention be connected to a CAD (Computer Aided Design) tool to be able to generate the block diagrams of the parts which are defined in each PBS element. It is also advantageous that the system of the invention be connected to a PLM (Product Life cycle Management) tool to be able to maintain the configurations of the products, SBEs and BBs through their life and to manage their obsolescence.

The invention is not limited to the content of the specification. The scope of the invention is only limited by the claims which follow.

1. A computer aided engineering method comprising the steps of: i) parsing key requirements of PBS elements of N products having similar applications, N being at least equal to two; ii) constructing P N-plets of PBS elements of at least some of the N products, each N-plet being populated with PBS elements which have a compliance rate with key requirements which is at least equal to a preset value; iii) if P is at least equal to one, defining for at least this one N-plet the specifications of a SBE meant to replace this one N-plet, wherein said defining is performed by optimizing a combination of criteria chosen in a list comprising at least compliance rate with key requirements, cost-performance trade-off, development cost and development time-line of each product.

2. The computer aided engineering method of claim 1 wherein at least one of said N products meets the key requirements of at least one client through at least two different programs.

3. The computer aided engineering method of claim 2 wherein the at least one of said N products meets the key requirements of at least two clients which act on two different markets.

4. The computer aided engineering method of claim 1 further comprising the step of defining the key requirements of said PBS elements by performing an operational and functional analyzis of at least one client or prospect.

5. The computer aided engineering method of claim 1 further comprising the step of defining a support and obsolescence plan for at least one of the N products.

6. The computer aided engineering method of claim 1 further comprising the step of defining at least two levels of PBS elements for said SBE.

7. The computer aided engineering method of claim 6 further comprising the step of creating a part list for at least some of said PBS elements.

8. The computer aided engineering method of claim 7 further comprising the step of generating block diagrams for at least some parts of said part list.

9. The computer aided engineering method of claim 1 further comprising the steps of: i) defining building blocks of Q SBEs having similar functions, Q being equal at least to two; ii) parsing key requirements of said building blocks of said Q SBEs; iii) constructing R Q-plets of building blocks of at least some of the Q SBEs, each Q-plet being populated with building blocks which have a compliance rate with key requirements which is at least equal to a preset value; iv) if R is at least equal to one, defining for at least this one Q-plet the specifications of a standard building block meant to replace this one Q-plet, said defining being performed by optimizing a combination of criteria chosen in a list comprising at least compliance rate with key requirements, cost-performance trade-off, development cost and development time-line of each SBE.

10. The computer aided engineering method of claim 9 further comprising the step of defining at least two levels of PBS elements for said building block.

11. The computer aided engineering method of claim 10 further comprising the step of creating a part list for at least some of said PBS elements.

12. The computer aided engineering method of claim 11 further comprising the step of generating block diagrams for at least some parts of said part list.

13. A computer aided engineering system comprising modules capable of performing the steps of: i) parsing key requirements of PBS elements of N products having similar applications, N being at least equal to two; ii) constructing P N-plets of PBS elements of at least some of the N products, each N-plet being populated with PBS elements which have a compliance rate with key requirements which is at least equal to a preset value; iii) if P is at least equal to one, defining for at least this one N-plet the specifications of a SBE meant to replace this one N-plet, said defining being performed by optimizing a combination of criteria chosen in a list comprising at least compliance rate with key requirements, cost-performance trade-off, development cost and development time-line of each product.

14. The computer aided engineering system of claim 13 wherein a module is capable of performing the steps of: i) defining building blocks of Q SBEs having similar functions, Q being equal at least to two; ii) parsing key requirements of said building blocks of said Q SBEs; iii) constructing R Q-plets of building blocks of at least some of the Q SBEs, each Q-plet being populated with building blocks which have a compliance rate with key requirements which is at least equal to a preset value; iv) if R is at least equal to one, defining for at least this one Q-plet the specifications of a standard building block meant to replace this one Q-plet, said defining being performed by optimizing a combination of criteria chosen in a list comprising at least compliance rate with key requirements, cost-performance trade-off, development cost and development time-line of each SBE.

15. The computer aided engineering system of claim 13 further comprising a data repository module wherein marketing, product and technology data are made available to authorized users.

16. The computer aided engineering system of claim 13 further comprising an interface with a CAD system to generate block diagrams of at least one part of at least one SBE.

17. The computer aided engineering system of claim 13 further comprising an interface with a PLM system to manage configurations and obsolescence of parts of at least one SBE.
